(19) United States
(12) Patent Application Publication
(10) Pub. No.: US 2026/0210415 A1
(43) Pub. Date: Jul. 23, 2026

(54) METHOD FOR ADAPTING A CLUTCH FOR A VEHICLE

(71) Applicant: ZF Friedrichshafen AG, Friedrichshafen (DE)

(72) Inventors: Markus Birk, Mittelbiberach (DE); Steffen Biel, Friedrichshafen (DE)

(73) Assignee: ZF Friedrichshafen AG, Friedrichshafen (DE)

(21) Appl. No.: 19/138,941

(22) PCT Filed: Nov. 20, 2023
(86) PCT No.: PCT/EP2023/082318

§ 371 Date: Jun. 13, 2025

(30) Foreign Application Priority Data
Dec. 16, 2022 (DE) 10 2022 213 781.7

(51) Int. Cl. F16D 48/06

(52) U.S. Cl. CPC F16D 48/06; F16D 2500/10412; F16D 2500/30404; F16D 2500/70647

(57) ABSTRACT

Adapting a clutch (2) for a vehicle (4) includes outputting (S2) a parameter to the clutch (2) in order to operate the clutch (2) using the parameter, receiving (S3) an operating parameter corresponding to the operation of the clutch (2), determining (S4) a clutch temperature using a neural network configured to determine the clutch temperature based on a learned relationship between the clutch temperature and the received operating parameter, determining (S5) whether clutch temperature corresponds to a target temperature; and if the determined clutch temperature corresponds to the target temperature, outputting (S6) the parameter to the clutch (2) in order to adapt the clutch (2) using the parameter. Also disclosed is a computing unit (6) configured to carry out the method and a vehicle (4) having a clutch (2) adapted by means of a computing unit (6) that carries out the method.

### RELATED APPLICATIONS

This application claims the benefit under 35 U.S.C. § 371 as a U.S. National Phase Application of application no. PCT/EP2023/082318, filed on 20 Nov. 2023, which claims the benefit of German Patent Application no. 10 2022 213 781.7 filed on 16 Dec. 2022, the contents of which are hereby incorporated herein by reference in their entireties.

### TECHNICAL FIELD

The present invention relates to a method for adapting a clutch for a vehicle. Furthermore, the present invention relates to a computing unit which is designed to carry out steps of the method for adapting a clutch. Furthermore, the present invention relates to a vehicle with a clutch, wherein the clutch has a control unit which is designed to control an adapted clutch.

### BACKGROUND

It is known from the prior art that a clutch for a vehicle is adapted manually by a user. The adaptation is carried out iteratively, with parameters for the clutch being specified by the user and improved iteratively.

### SUMMARY OF THE INVENTION

The present invention relates, in a first aspect, to a method for adapting a clutch for a vehicle. The adaptation of a clutch may include adjusting or parameterizing the clutch. One or more adaptations may be made, for example, an adaptation for a standstill, an adaptation for a switching operation, an adaptation for constant speed, and, alternatively or additionally, an adaptation for a repair. After adaptation, the clutch can be used in the vehicle in order to operate the clutch as described above. as described above. The clutch can be a multi-plate clutch, for example. The clutch can be used in a modular manner in a test bench and can also be used or installed in a vehicle. The vehicle can be a passenger car, a truck, or a work machine, such as a construction machine. A computing unit can be designed to carry out steps of the method as described below.

The method comprises outputting a parameter to the clutch for operating the clutch with the parameter. Issuing a parameter for operating the clutch with the issued parameter may include an operating output. The output may include sending a signal with data comprising the parameter. One parameter or, alternatively, several parameters can be output to the clutch. Parameters can be, for example, related to a clutch kiss point, hydraulic pressure, or torque transfer of the clutch. Various parameters can be output for different operating modes, for example for a standstill, a switching operation, constant speed operation, a repair, or an end-of-line operating mode, i.e., an operating mode after a manufacturing process. The operation can be a test operation. The clutch can be operated on a test bench or alternatively in the field, installed in a vehicle. The output can be carried out via a data interface of the computing unit, for example.

The method further comprises receiving an operating parameter which corresponds to the operation of the clutch. The operating parameter which corresponds to the operation of the clutch can be measured when the clutch is operated with the output parameter. The operating parameter can be, for example, a sump temperature of the clutch which is present when the clutch has been operated with the output parameter(s). Receiving may include reading data, including operating parameters. Alternatively, or additionally, the receiving may include measuring the operating parameter. One or more operating parameters can be received.

Furthermore, the method comprises determining a clutch temperature by means of a neural network. The neural network is designed to determine the clutch temperature based on a learned relationship between the clutch temperature and the received operating parameter. The relationship can be learned through training, and the training can be validated or verified through validation. For this purpose, training data comprising the clutch temperature as output data and the operating parameters as input data can be used. One or more operating parameters can be included as input data in the training data.

The method also includes determining whether the determined clutch temperature corresponds to a target temperature. The target temperature can be an absolute target temperature. The target temperature can be a relative target temperature. An absolute target temperature can be predetermined in degrees Celsius or Kelvin. With a relative target temperature, the target temperature can be predetermined, for example, as a specific quantile of a set of temperatures, such as clutch temperatures. The quantile can be, for example, a median, a tercile, a quartile, or a decile.

If it has been determined that the specified clutch temperature corresponds to the target temperature, the parameter is output to the clutch to adapt the clutch with the parameter. Outputting the parameter to the clutch for clutch adaptation may include an adaptation output. One or more parameters can be output to the clutch for adaptation. Outputting for adaptation may include setting the clutch with the parameter(s). The parameter(s) for which a clutch temperature corresponds to the target temperature can be output. Alternatively, if it is determined that the determined clutch temperature does not correspond to the target temperature, a different parameter may be output to the clutch in order to operate the clutch with the other parameter, wherein the other parameter is different from the first parameter output for operating the clutch. Further steps in the method, up to determining whether the specified clutch temperature corresponds to a target temperature, can also be performed in a loop until a specific clutch temperature corresponds to the target temperature.

For adapting a clutch for a vehicle, or for adapting a clutch of a vehicle, it is therefore possible to dispense with a rule-based model for temperature prediction. Using a neural network to determine the clutch temperature can be less complex than a rule-based model for temperature prediction. The temperature prediction for a parameter for operating and adapting the clutch may be necessary and relevant, as clutch wear in a vehicle can depend on temperature behavior. The temperature behavior may depend on the parameters used for adaptation.

Another embodiment of the method may be characterized in that the output for operating the clutch may comprise several combinations of parameters. The output for operating the clutch may comprise the output of several parameters, and several or all combinations of these parameters may be output for operating the clutch. This allows different parameter sets, each of which may be intended for operating the clutch, to be output to the clutch. A parameter set can consist of a specific combination of specific parameters. Furthermore, for several of the combinations, an operating parameter of a respective combination can be received. For all combinations that have been output for operating the clutch, one operating parameter or, alternatively, several operating parameters can be received for a respective combination. It is possible to determine a respective clutch temperature depending on the respective operating parameter received, alternatively on the respective operating parameters received, for several, alternatively for all, of the operating parameters received. It can be determined whether the specific clutch temperature corresponds to a target temperature for several or all of the specific clutch temperatures. The output can be used to adapt the clutch from one of several, alternatively several or all, combinations of parameters whose respective specified clutch temperature corresponds to the target temperature.

By outputting multiple combinations of parameters in order to operate the clutch, a brute force approach can be implemented using this method. This allows different parameters and different combinations of different parameters to be used, each with a specific combination of parameters to cause the clutch to operate and, as a result, to receive one or more operating parameter which corresponds to the operation of the clutch. This eliminates the need for a more complex, iterative process, which can take a long time. The clutch temperatures can be determined jointly in a joint step of determining the clutch temperatures for the respective received operating parameters from a combination of parameters for operating the clutch. Furthermore, when determining whether the respective determined clutch temperature corresponds to a target temperature, a comparison of clutch temperatures with a target temperature can also be carried out in a time-saving manner. An output for adapting the clutch can be issued using one of several combinations of parameters, the respective specified clutch temperature of which corresponds to the target temperature and can thus provide operation with an adapted clutch that can ensure optimum temperature input. The method allows the parameter(s) to be determined in a time-saving manner in order to enable such adaptation of the clutch.

Another embodiment relates to a method characterized in that the target temperature can be a minimum relative temperature and it is possible to determine which of the determined clutch temperatures is the minimum in comparison with several, or alternatively all, of the determined clutch temperatures. The combination of parameters for adapting the clutch whose specific clutch temperature has been determined as minimum can be output. One or more combinations of parameters can be output for adapting the clutch, whose specific clutch temperature has been determined as the minimum.

The method can therefore be used to ensure that the clutch is adapted in a temperature-optimized manner, i.e., optimized for a minimum clutch temperature during operation or use after the clutch has been adapted. In combination with the brute force approach described above, this can provide a particularly time-saving method for adapting a clutch.

According to a further embodiment, a method is shown, characterized in that one or, alternatively, several parameters can be received with a set of possible associated parameter values. Receiving may comprise reading and, alternatively or additionally, obtaining data with the parameter(s) and, alternatively or additionally, parameter values. Associated parameter values can include different values of a parameter. For example, different associated parameter values of a hydraulic pressure, as parameters, may comprise discrete or, alternatively or additionally, continuous values of the pressure in, for example, pascals. Furthermore, a subset of the received parameter values can be selected, and the parameters for operating the clutch can be output depending on the selection of the subset of parameter values. The selection can be made by a computing unit, alternatively by a user. The selection can be made manually, based on rules, or alternatively or additionally by a neural network. The subset can represent a true subset of the received parameter values, and not all received parameters with associated parameter values can be output to the coupling in order to operate the clutch.

This allows a large set of parameters and parameter values output to the clutch for clutch operation to be limited. This allows for more resource-efficient operation and also for receiving operating parameters, the determination of clutch temperatures and, if necessary, the output of parameters for adaptation, since the steps of the method do not have to be carried out for all received parameters and associated parameter values. The selection can be made based on the functionalities of the clutch, for example. For example, a functionality may reflect a driving characteristic. The driving characteristics can be sporty, economical, or comfortable, for example. This allows various parameter values, such as a specific clutch pressure or hydraulic pressure, which will result in a sporty or, alternatively, a comfortable driving style, to be used depending on the respective desired functionality in order to output these to the clutch for operation.

According to a further embodiment, a method is shown, characterized in that a selection of a subset of the combinations of the received parameters can be made. The subset can be a true subset, wherein certain combinations that would be possible according to combinatorics and the set of received parameters and the associated parameter values can be omitted. The parameters for operating the clutch can be output depending on the selection of the subset of combinations of parameters. When outputting the parameters for operating the clutch, it is possible to dispense with Outputting a certain initial subset of combinations of the received parameters to the clutch for operating the clutch. A second subset, which may be disjoint from the first subset, can be output to the clutch to operate the clutch. This allows the combination of parameters and parameter values to be further restricted, thereby implementing a resource-saving option for the method that is comparable to the previous embodiment.

According to a further embodiment, a method is shown, characterized in that at least one selection of the subset of parameter values and the selection of the subset of combinations of parameters can be performed by a user. The user may be an end user, such as a developer, who adapts the clutch. The selection of the subset of parameter values and, alternatively or additionally, the selection of the subset of parameter combinations can be carried out by the user with user support, i.e. partially manually, or alternatively completely manually.

This allows users, such as developers of driving functions, to contribute their experience to the adaptation of the clutch. The brute force approach can thus be combined with the experience value of the developer and the user. This provides a resource-saving and efficient method for adapting the clutch.

According to a further embodiment, a method is shown, characterized in that the parameter for adaptation can be output for an initial adaptation of the clutch. The initial adaptation of the clutch can be carried out after a production process and before delivery of a vehicle equipped with such a clutch. The initial adaptation of the clutch can also be carried out on a test bench, for example. The initial adaptation can represent the first adaptation of the clutch in the life cycle of the clutch.

This method allows a response to be made to fluctuations in the production of the clutch and to fluctuations in the production of clutch components. For example, hydraulic valves that may be installed in the clutch can exhibit production fluctuations. This initial adaptation allows a response to be made to production fluctuations in such hydraulic valves and, if necessary, other elements of the clutch. This means that a comparable adaptation and thus parameterization with regard to the behavior of the clutch can be represented for a wide range of clutches using this method.

According to a further embodiment, a method is shown, characterized in that the parameter for adaptation can be output for ongoing adaptation of the clutch. The ongoing adaptation of the clutch may, for example, be an adaptation of the clutch in a test bench that has already been initially adapted beforehand. Alternatively, the ongoing adaptation of the clutch may be an adaptation of a clutch in the field, for example, a clutch installed in a test vehicle or in an end user's vehicle.

By adapting the parameter in this way and outputting it for ongoing adaptation of the clutch, it is possible to respond to clutch-specific wear. For example, a first driver with a first vehicle and a first clutch installed therein may drive in a particularly sporty manner and cause different wear on the friction elements in the clutch than a second driver with a second vehicle and a second clutch installed therein who has a more defensive driving style. By outputting the parameter, or the parameters or parameter values, for adaptation, it is possible to respond to different wear processes in different clutches of different vehicles in such a way that each clutch can be adapted to keep the driving behavior of all clutches as comparable as possible, even after different wear effects.

A second aspect of the present invention relates to a computing unit. The computing unit can be designed and installed in a vehicle, for example in a test vehicle or in an end-user vehicle. The computing unit may be provided in a test bench. The computing unit can be provided locally or in a cloud, either as an alternative or in addition. The computing unit may have interfaces for receiving and reading in data, such as parameters and operating parameters, and for outputting data for operation and, alternatively or additionally, for adapting the clutch. The computing unit can be designed to carry out steps of the method for adapting the clutch for a vehicle according to an embodiment of the first aspect of the present invention. The computing unit can be designed to carry out at least one, some, or all of the steps of the method. If the computing unit does not carry out all steps of the method for adapting a clutch, a user can carry out the remaining steps. The clutch for a vehicle can be the clutch of a specific vehicle; for example, the clutch may be installed in a specific vehicle.

The present invention relates, in a third aspect, to a vehicle with a clutch. The vehicle may be a passenger car, a truck, or a work machine, such as an agricultural or construction machine. The clutch can be a multi-plate clutch. The clutch may comprise a control unit and a storage medium. The control unit may be a control device of the vehicle, and the storage medium may be a non-volatile memory. The control unit can be designed to control the clutch. The control unit and the clutch can be connected electrically and alternatively or additionally electronically. An adaptation of the clutch by means of a computing unit implementing the method according to an embodiment of the first aspect of the invention may be carried out or may already have been carried out. The parameter for adapting the clutch can be output to the storage medium or may already have been output. Several parameters can also be output to adapt the clutch to the storage medium. The storage medium can store the parameter(s) that have been output, and the control unit can use the parameters stored on the storage medium to control the clutch. This enables control of an adapted clutch.

### BRIEF DESCRIPTION OF THE FIGURES

FIG. 1: schematically shows a computing unit and a vehicle according to embodiments of the invention.

FIG. 2: schematically shows steps of a method for adapting a clutch for a vehicle according to an embodiment of the invention.

### DETAILED DESCRIPTION OF EMBODIMENTS

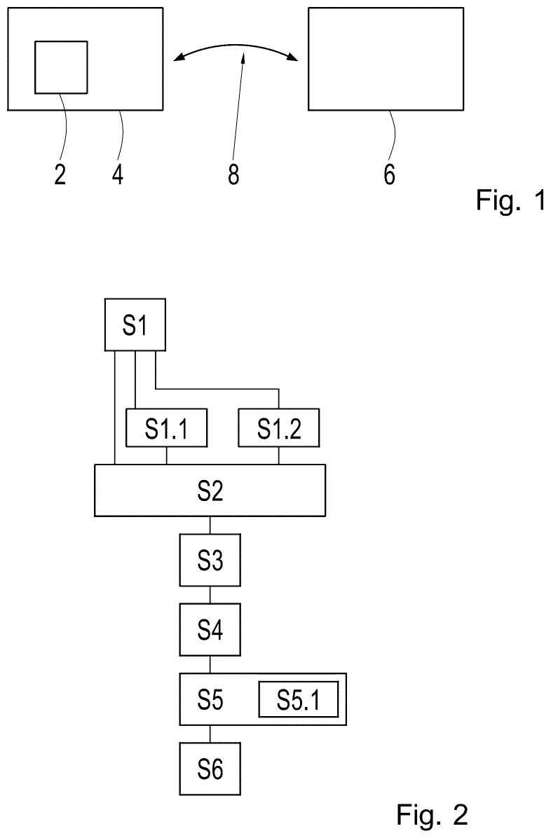

FIG. 1 schematically shows a computing unit 6 according to an embodiment of the invention. The computing unit 6 is designed to carry out steps of a method, which are shown schematically in FIG. 2, for adapting a clutch 2 of a vehicle 4. The computing unit 6 and the vehicle 4 are connected to each other via a data transmission device 8, in this case a wireless connection.

As shown in FIG. 2, the method comprises receiving S1 a parameter with a set of possible associated parameter values. This involves receiving several parameters, each with several associated parameter values. These are received by the computing unit 6 via an interface. A user selects S1.1, a subset of the received parameter values. Furthermore, the user selects S1.2 a subset of combinations of the received parameters. Parameters include, for example, a kiss point, a slip point, a torque, or a torque transfer of a clutch 2. By selecting S1.1 and S1.2, the user focuses on parameters and parameter values and thus on possible combinations of these parameters and parameter values that are of interest to the user.

The received parameter and thus several parameters and parameter values are output S2 to the clutch 2, wherein this is carried out by the computing unit 6 via the data transmission device 8 and interfaces of the clutch 2 and the computing unit 6, which are not shown. Output S2 comprises sending data with the parameters to clutch 2. Operating parameters are then measured for corresponding combinations of parameters during operation of clutch 2. These measured operating parameters are sent from clutch 2 via the data transmission device 8 to the computing unit 6, and the operating parameters of the respective combinations of parameters for operating the clutch are received S3. This results in data records in which one or more specific operating parameters are assigned to a specific combination of parameters and parameter values.

Using the operating parameters received, a neural network determines S4 a respective clutch temperature for a respective combination. Furthermore, a determination S5 is made as to whether the clutch temperature corresponds to a target temperature. This involves determining S5.1 a minimum clutch temperature, i.e., which of the determined clutch temperatures is the minimum in comparison to all determined clutch temperatures. The lowest clutch temperature is determined. For this purpose, the corresponding operating parameters and parameter values that were output for operating clutch 2 with this minimum clutch temperature are determined. Then, the respective parameter with the minimum clutch temperature, or the parameter of the combination of parameters with the minimum clutch temperature, is output S6 to the clutch 2 for final adaptation of the clutch 2. The output S6 comprises sending data via the data transmission device 8 to the clutch 2, wherein the output parameters are stored on a storage medium (not shown) of the vehicle 2. This completes the adaptation of clutch 2 and thus the method. A control unit, not shown, is provided for controlling the adapted clutch 2 using the parameters stored on the storage medium.

### REFERENCE NUMBERS

2 clutch
4 vehicle
6 computing unit
8 data transmission device
S1 (Step) receiving a parameter with a set of parameter values
S1.1 (Step) selection of a subset of the received parameter values
S1.2 (Step) selection of a subset of combinations of the received parameters
S2 (Step) outputting the parameter to the clutch for operation
S3 (Step) receiving an operating parameter
S4 (Step) determining a clutch temperature
S5 (Step) determine whether the clutch temperature corresponds to the target temperature
S5.1 (Step) determining a minimum clutch temperature
S6 (Step) outputting the parameter to the clutch for adaptation

1. A method for adapting a clutch (2) for a vehicle (4), the method comprising:
outputting (S2) a parameter to the clutch (2) in order to operate the clutch (2) using the parameter;
receiving (S3) an operating parameter which corresponds to the operation of the clutch (2);
determining (S4) a clutch temperature by means of a neural network configured to determine the clutch temperature on the basis of a learned relationship between the clutch temperature and the received operating parameter;
determining (S5) whether the determined clutch temperature corresponds to a target temperature;
determining that the determined clutch temperature corresponds to the target temperature; and
outputting (S6) the parameter to the clutch (2) in order to adapt the clutch (2) using the parameter.

2. The method according to claim 1, wherein:
outputting (S2) the parameter to the clutch (2) comprises several combinations of parameters, and
for at least some of the several combinations, the method includes receiving (S3) an operating parameter of a respective combination taking place;
determining (S4) the clutch temperature in dependence on the respective received operating parameter takes place for the at least some received operating parameters;
determining (S5) whether the determined clutch temperature corresponds to the target temperature is performed for several of the determined clutch temperatures; and
outputting (S6) the parameter to the clutch (2) is performed for one of several combinations of parameters whose respective determined clutch temperature corresponds to the target temperature.

3. The method according to claim 2, wherein:
the target temperature is a minimum relative temperature, and wherein the method further comprises:
determining (S5.1) which of the determined clutch temperatures is a minimum temperature in comparison with a plurality of determined clutch temperatures; and
outputting (S6) the parameter to the clutch (2) whose determined clutch temperature has been determined as the minimum.

4. The method according to claim 1, comprising:
receiving (S1) a parameter with a set of possible associated parameter values;
selecting a subset of the received parameter values;
outputting the parameters to the clutch (2) depending on the selection (S1.1) of the subset of the received parameter values.

5. The method according to claim 1, comprising:
selecting a subset of the combinations of the received parameter values; and
wherein the outputting (S2) of the parameters to the clutch (2) is made depending on the selection (S1.2) of the subset of the combinations of the received parameter values.

6. The method according to claim 6, wherein at least one of selecting (S1.1) the subset of received parameter values and selecting (S1.2) the subset of combinations of parameters is performed by a user.

7. The method according to claim 1, comprising outputting (S6) the parameter comprises adapting an initial adaptation of the clutch (2).

8. The method according to claim 7, wherein outputting (S6) the parameter to the clutch for adapting the initial adaptation takes place for ongoing adaptation of the clutch (2).

9. A computing unit (6) having machine-executable code comprising instructions that, when executed, carry out steps of the method for adapting the clutch (2) for a vehicle (4) according to claim 1.

10. A vehicle (4) with a clutch (2), wherein the clutch (2) has a control unit and a storage medium, wherein the control unit configured to control the clutch (2), and wherein an adaptation of the clutch (2) is carried out by means of a computing unit (6) that carries out the method according to, claim 1, and the parameter for adapting the clutch (2) is output (S6) to the storage medium.
